(19) United States
(12) Patent Application Publication
(10) Pub. No.: US 2003/0117275 A1
(43) Pub. Date: Jun. 26, 2003

(54) Apparatus for detecting potential tire failure

(76) Inventor: D. Scott Watkins, Birmingham, MI (US)

Correspondence Address: Carl M. Davis II, Baker, Donelson, Bearman & Caldwell, Suite 900, Five Concourse Parkway, Atlanta, GA, 30328, US

(21) Appl. No.: 10/055,235

(22) Filed: Oct. 25, 2001

(51) Int. Cl. B60C 23/00

(52) U.S. Cl. 340/442; 340/600; 340/425.5; 348/148

(57) ABSTRACT

A tire failure detector (10) in which at least one receiver (42) mounted in a housing (12) generates a signal representative of a thermal characteristic of a portion of a tire (18) sensed by the receiver (42). A processor (46) detects an abnormal signal carried by a carrier (44) from the receiver (42) and communicates the abnormal signal to a display (50) which presents at least an image representative of the detected abnormal signal to notify an observer of the abnormal signal detected. A cover (22) inside the housing (12) protects the receiver (42) from debris, while a nozzle (32) communicates through a tube (34) a supply of a pressurized fluid (38) for cleaning debris from the cover (22).

### TECHNICAL FIELD

The present application relates to apparatus for detecting tire failures. More particularly, the present invention is directed to apparatus that monitors thermal changes in tires in order to alert observers of impending tire failures before occurrence.

### BACKGROUND OF THE INVENTION

Tires serve the important function of providing an insulating conveying mechanism between a vehicle's wheels and the roadway. Although tires are used on many types of vehicles including cars, motorcycles, busses, and planes, conventional tires have a limited life span and must be replaced with some frequency. Over time and with use, tires become worn or may become damaged. Defects in manufacturing of a tire may also shorten the life of a tire. Unfortunately, it is often difficult to predict the time at which a tire will fail and if a vehicle is in motion when a tire fails, the results cause damage to property and possible injury to persons. When a vehicle's tire fails as the vehicle is traveling over a roadway or other surface, the forces occurring between the remaining intact tires and the roadway in combination with the forces occurring between the failed tire and the roadway, often cause the driver of the vehicle to lose drivable control of the moving vehicle. As a driver loses the ability to control the drive path of a vehicle whose tire has failed, it is not uncommon for the vehicle to be propelled into a side roll. A vehicle which rolls will cause damage to property and often injury to the occupants of the vehicle.

With conventional vehicles, tire wear is typically monitored only by an observer visually inspecting the tires on a vehicle. This monitoring of tires typically entails an observer inspecting tires to determine if the visible physical characteristics of the tire, created by wear and tear of the tire, are such that tire failure is possible. When performing a visual inspection of a tire, an observer examines the amount of tread remaining on the external surface of the tire, the pattern of the tread remaining on the external surface of the tire, and the uniformity of the tread surface of the tire. If these inspections reveal abnormalities or excessive wear, replacement of the tire may be indicated. Also, the inspection determines whether abnormalities such as bulges, cracks, cuts, or other, exist in the tire or if tire inflation is abnormal. Since such visual inspections are necessarily limited by the observer's physical ability to observe and evaluate tire status from the physical characteristics of the external surfaces of the tire, observers performing visual inspections of tires may lack the ability to accurately pinpoint a time at which a tire will actually fail. Also, as is the case, one performing visual inspections may not be able to perceive subtle changes occurring within the tire which could denote potential tire failure because subtle changes occurring in the tire may be wholly undetectable by the naked eye. Furthermore, visual inspection of a tire is limited to the inspection of the tire in a stationary position and does not provide a means in which to measure the temperature changes occurring in the tire and on the surfaces of the tire as the tire rotates against the roadway. Finally, visual inspections occur at a single point in time and do not afford a means to continuously monitor the thermal characteristics of a tire in motion for failure.

It is known that tires may be manufactured to include a system for monitoring the tire pressures and displaying real-time pressure values on a dashboard display inside a vehicle. Tires with a conventional pressure monitor typically have sensors mounted in the interior of the tire within the pressurizable cavity. The sensors periodically measure air pressure in the tire and compensate the detected pressures for changes in the temperature in the tire and for changes in altitude. A transmitter transmits the measured air pressure, via RF or other transmission, to a receiver. The receiver controls a display which indicates an alarm condition when the tire pressure falls below a certain pre-defined threshold.

It is been observed however that as a tire approaches failure and before a tire fails, the temperature in and around the failure point of the tire will elevate, signaling that the tire is nearing the end of its lifespan. Notwithstanding the widespread use of tires, the prior devices for thermal monitoring of tires have not met with widespread usage and acceptance.

Accordingly, there is a need in the art for an improved apparatus for detecting thermal characteristics in tires during operation, monitoring changes in the thermal characteristics, and alerting as to detected changes, in order to avoid possible tire failure during operation. It is to such that the present invention is directed.

### BRIEF DESCRIPTION OF THE PRESENT INVENTION

The present invention provides an apparatus for detecting the thermal characteristics of a tire in order to alert as to potential tire failure. The detection apparatus of the present invention comprises a housing adapted for being attached to a portion of a motor vehicle. A receiver is mounted in the housing to generate a signal representative of a thermal characteristic of a portion of a tire as sensed by the receiver. A cover disposed at a first end of the housing protects the receiver from debris while a supply of pressurized fluid stored remotely is selectively communicated through a tube and sprayed by a nozzle into the housing to remove debris collected on the receiver. Signals from the receiver are communicated to a processor which operates a display. The display presents at least an image representative of a detected abnormal signal, so that an observer, detecting the display of an abnormal signal, may attend to the condition causing the abnormal signal.

Objects, features, and advantages of the present invention will become apparent from a reading of the following detailed description of the invention and claims in view of the appended drawings.

### BRIEF DESCRIPTION OF THE DRAWINGS

FIG. 1 illustrates a partially cut-away side view of a motor vehicle having an apparatus according to the present invention for detecting tire failure.

FIG. 2 is a detailed perspective view of the apparatus shown in FIG. 1.

FIG. 3 illustrates a front view of a second embodiment of the apparatus for detecting tire failure constructed in accordance with the present invention.

FIG. 4 is a front view showing a third embodiment of the apparatus for detecting tire failure constructed in accordance with the present invention.

FIG. 5 is a side view of a fourth embodiment of the apparatus for detecting tire failure constructed in accordance with the present invention.

### DETAILED DESCRIPTION OF THE PREFERRED EMBODIMENTS

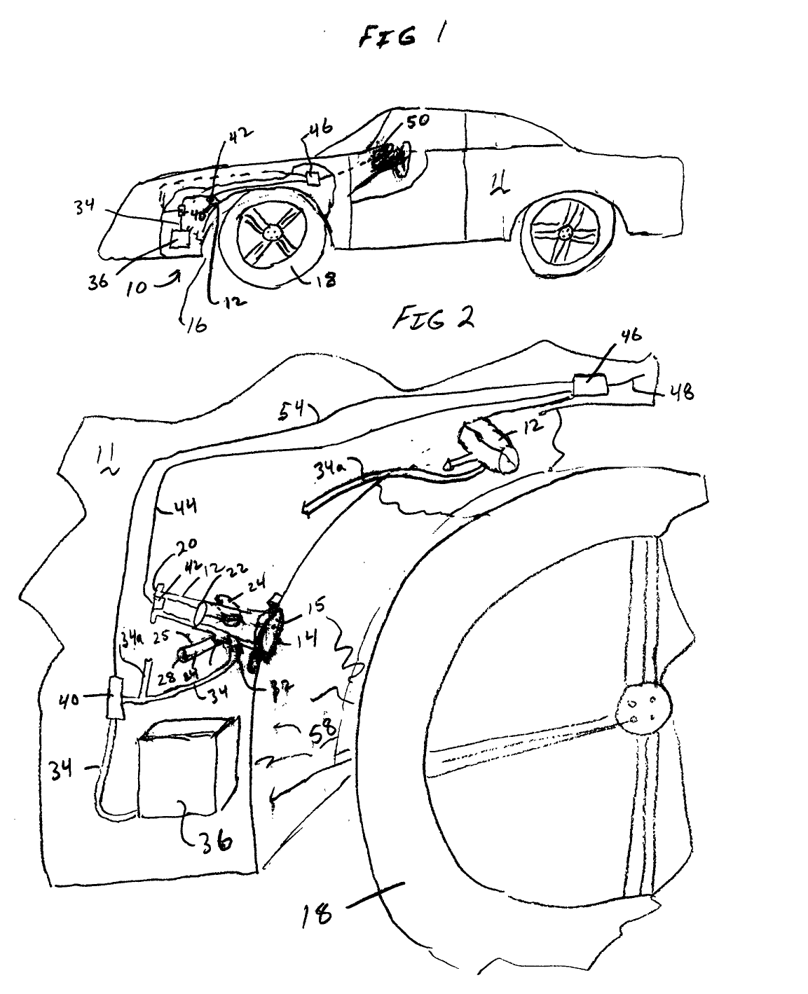

Referring now in more detail to the drawings, in which like numerals indicate like parts throughout the several views, there is shown in FIG. 1 a detection apparatus 10 in a first preferred form of the invention for monitoring a tire 18 and alerting an observer as to a detected potential tire failure. The apparatus 10 includes a housing 12 that mounts in a wheel well 16 of a motor vehicle 11 oriented towards the tire 18. The housing 12 includes a receiver 42 at a closed end 20 of the housing 12 for sensing thermal characteristics of the tire 18, as discussed below. The apparatus 10 further includes a fluid chamber 36 connected by a tube 34 through a pump 40 to the housing 12. The receiver 42 communicates signals representative of the detected thermal characteristics to a processor 46. The processor 46 evaluates the signals and controls presentation of the signals on a display 50.

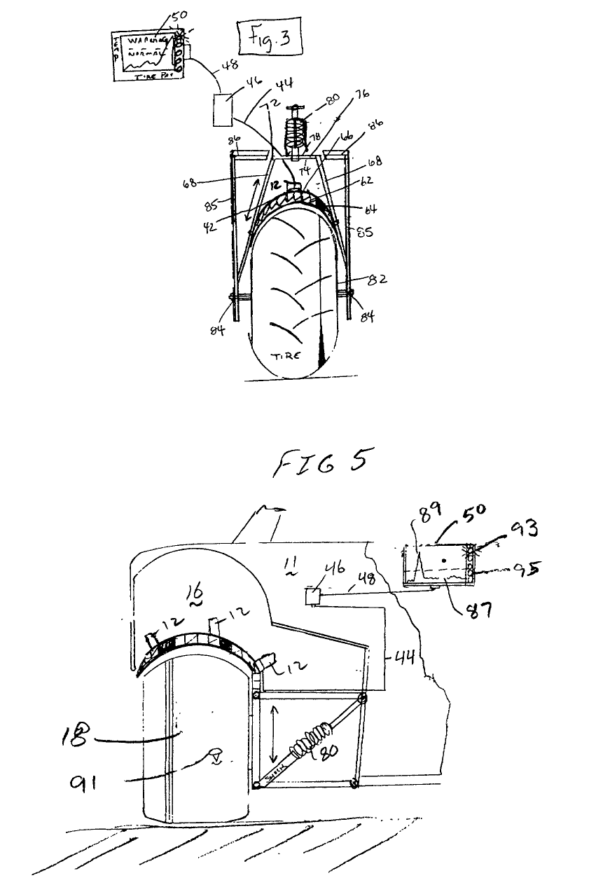

As is shown in greater detail in FIG. 2, the housing 12 of the detecting apparatus 10 is a generally hollow elongate barrel having an open end 14 adapted to be mounted to a portion of the wheel well 16. The housing 12 is mounted to the wheel well 16 in a location with the open end 14 towards the area of the tire 18 to be monitored. The housing 12 in the illustrated embodiment also contains a transparent cover 22 or lens disposed remote from the open end 14 and whose outer edges 23 form an airtight seal with an inner wall 15 of the housing 12.

A pair of tubes 25 extend outwardly from the housing 12 intermediate the two ends of the housing 12 at oblique angles relative to a longitudinal axis of the housing. The tubes 25 each define hollow passages 24 which each communicate between the housing 12 and an outlet 28. Each of the passages 24 is closed a one-way valve 30 that opens in a direction outwardly of the housing 12, for a purpose discussed below.

The housing 12 defines a port 32 in the wall of the housing 12 intermediate the passages 24 and the open end 14 of the housing 12. The port 32 connects through a tube 34 and defines a nozzle oriented generally towards the cover 22. An opposing end of the tube 34 connects to a chamber 36 adapted to store a cleaning fluid 38. A pump mechanism 40 operatively engages the chamber 36 for pumping fluid 38 out of the chamber 36, through the tube 34 and the nozzle 32, onto the cover 22 in the housing 12.

It is to be appreciated that in the practice of the present invention, additional housings 12 may be gainfully employed for monitoring the tire 18. For example, three housings 12 disposed in the wheel well 16 provides one for monitoring an exterior sidewall of the tire 18, one for monitoring the interior sidewall of the tire 18, and the third housing for monitoring a tread surface 56 of the tire 18. FIG. 2 for example illustrates a second housing 12 with the tube 34a, for monitoring a sidewall of the tire 18.

A receiver 42 mounts inside the housing 12 inwardly of the closed end 20. The receiver 42 is adapted to sense thermal characteristics of the tire 18 and to generate signals representative thereof. The receiver 42 engages a first cable 44 capable of transmitting signals to the processor 46. The processor 46 mounts in a remote portion of the vehicle 11. The processor 46 is a commercially available microprocessor adapted to receive and evaluate signals generated by the receiver 42. The processor 46 stores in a memory device a value representative of the thermal characteristics which the signals represent, for example, a running average of the signals representative of the detected thermal characteristics. The processor 46 compares the characteristics of a signal most recently received with the characteristic of historically received signals stored in the memory device of the processor 46. The processor 46 takes a specified course of action depending upon the relative similarity or difference between the characteristic of the most recent signal received from the receiver 42 and the historical data stored by the processor 46.

A second cable 48 capable of sending a display signal generated by the processor 46 connects the processor 46 with a remote display monitor 50. In the illustrated embodiment, the display monitor 50 mounts in a dashboard of the motor vehicle 11. The display 50 receives the display signal communicated by the processor 46, converts the display signal to an image representative of the display signal, and presents on the display 50 an image representative of the signal to an observer.

A third cable 54 connects between the processor 46 and the pump 40. The cable 54 communicates a signal from the processor 46 for selective activation of the pump 40, as discussed below.

In use, the motor vehicle 11 is propelled in a selected direction as the tires 18 mounted on the motor vehicle 11 rotate. As the tires 18 rotate, the tread 56 of the tires 18 contacts a roadway or other surface. This contact of the tires 18 with the roadway generates heat within the tires 18 and on the surface of the tires 18. This heat creates a thermal field 58 on or near the outer surface of the tire 18. The thermal field 58 permeates the area defined by the wheel well 16 of the vehicle 11. The thermal field 58 communicates into the open end 14 of the housing 12 and through the elongate barrel housing 12. The receiver 42 senses the thermal field 58 generated by the tire 18, and, at a pre-set time interval, converts the thermal characteristics of the field 58 into an electrical impulse or signal representative of the thermal characteristics of the detected thermal field 58.

The receiver 42 then communicates the signal by the first cable 44 to the processor 46. The processor 46 receives the signal and compares the thermal characteristic represented by the received signal to the characteristic of thermal impulses historically received by the processor 46 from the receiver 42. If the most recent signal of thermal characteristic is within a pre-determined allowable variance from the historical thermal characteristic stored in the processor 46, the processor 46 includes the value of the signal for the most recent thermal characteristic in the historical thermal characteristic value stored in the processor 46.

The receiver 42 continues to sense the thermal field 58 generated by the tire 18, convert the characteristic of the thermal field 58 into representative electrical signals and communicate the signals in sequence to the processor 46 in the same manner as previously described. The processor 46 evaluates the most recently received signal as discussed above.

In one embodiment, the processor 46 generates a display signal representative of the signal for the thermal characteristic sensed by the receiver 42. The display signal is communicated by the second cable 48 to the display monitor 50 installed in the vehicle's dashboard 52 where an image representative of the display signal is presented. The display 50 provides a running image of the sequence of display signals, so that the observer may monitor the thermal characteristics of the tire 18.

However, the device 10 follows a different routine if the most recent signal communicated by the receiver 42 is outside the pre-determined allowable variance from the historical thermal data stored by the processor 46. A thermal characteristic that exceeds the pre-determined thermal characteristic threshold stored by the processor 46, may indicate that tire failure is possible. The processor 46 then generates an abnormal signal representative of the abnormal thermal characteristic sensed by the receiver 42. The abnormal signal is communicated by the second cable 48 to the display monitor 50 installed in the vehicle's dashboard 52 where an image representative of the abnormal signal is presented. An observer of that image is thereby alerted to abnormal thermal characteristics generated by the tire and can attend to the condition causing the abnormal signal before the subject tire 18 fails.

In one embodiment, the display monitor 50 is a LCD screen displaying the display signal and temperature value on an X-Y scale. In another alternative embodiment, the display monitor 50 is an LED light activated to alert observers as to the abnormal signal. To further direct the attention at the observer to the abnormal signal, another embodiment communicates a sound as an alert to the observers. In this way, the observer does not miss the abnormal signal, by inattention or other distraction. In yet another embodiment, the processor 46 communicates each signal representative of the detected thermal characteristic to the display monitor 50 for a running display of the detected thermal characteristics. The display 50 accordingly provides a running X-Y chart, with a temperature scale and plot of the detected thermal characteristics. The display 50 carries a unique symbol for each tire being monitored. In this embodiment, this observer can watch the display and observe the thermal activity of each tire. In an alternate embodiment, a separate light is activated and an alarm is sounded to alert the driver to an abnormal signal being displayed.

It is anticipated that use of the vehicle 11 may cause debris from the roadway or the tire 18 to accumulate on the cover 22 and inside of the housing 12. When debris collects on the cover 22, the receiver 42 becomes at least partially shielded from the thermal field 58 generated by the tire 18. In such instances the thermal characteristic of the field 58 detected by the partially covered receiver 42 may be less than the actual thermal characteristic. The signal representative of the detected thermal field will accordingly be less than that if the thermal characteristics were properly detected. The receiver 42 communicates the shielded signal by the first cable 44 to the processor 46. The processor 46 compares the thermal characteristic to historical data representative of thermal characteristics of impulses previously received. If the most recent signal is below a pre-determined thermal threshold stored by the processor 46, but outside a pre-determined thermal variance, the cover 22 and the housing 12 may be blocked. Thus, the capability of the receiver 42 to sense the thermal field 58 may be impeded by debris accumulated on the cover 22 or inside of the housing 12.

In such instances, the processor 46 generates a signal command that is communicated by the third cable 54 to the pump mechanism 40 housed in the pressurized chamber 36. The pump mechanism 40 pumps pressurized fluid 38 contained in the chamber 36 into the tube 34. The fluid 38 is propelled through the nozzle 32 into the housing 12 and forcefully onto the cover 22. The pressurized fluid 38 removes debris from the cover 22 and the inner walls 15 of the housing 12. The force and volume of the fluid 38 and the dislodged debris cause the first and second outlets 28, each closed by the one-way valve 30 coupled to the wall 15 of the housing 12, to open. This permits the fluid 38 and debris to exit the housing 12 through the passages 24 and out of the distal ends. The fluid 38 and debris thereby exit the passages 24 and are communicated from the housing 12. In an alternate embodiment, the pump 40 is selectively activated by the observer by a separate activation switch (not illustrated). While the fluid is contemplated to be a liquid or solution, it is to be appreciated that a pressurized aerosol or gas may also be gainfully employed, alone or in combination with a liquid.

Referring now to a separate second embodiment of the invention, FIG. 3 shows an arched concave shroud 62 or tire shield which extends across the tread 56 of the tire 18 in a spaced-apart relation, such as for a motorcycle. The shroud 62 mounts to an inner surface 64 of opposing legs 68 of a generally U-shaped biasing device 72. The shroud 62 is held at a pre-determined distance from the tire 18. The opposing legs 68 join to a lower surface 74 of a cross bar 76. The cross bar 76 also has an upper surface 78 which mounts to and supports a commercially available shock absorber 80 adapted to dampen vibrations resulting from the tires 18 rotating on the roadway or surface. The distal ends of the opposing legs 68 of the biasing device 72 connect to either side of a wheel 82 at joinder points 84. Also coupled at the joinder points 84 on either side of the wheel 82 is the longer member 85 of an L-shaped support arm 86. The support arms 86 are adapted to couple the wheel 82 to a frame of the vehicle 11.

The shroud 62 serves the identical mounting and support function as the wheel well serves in the embodiment depicted in FIGS. 1 and 2. The housing 12 mounts to the shroud 62 with the open end 14 of the housing 12 open towards the tire 18 to be monitored. As with the first embodiment, the housing 12 encases the receiver 42, and the first cable 44 connects the receiver 42 to the processor 46. The second cable 48 connects the processor 46 to the display 50 which is preferably installed on the vehicle in an observable position, for example, the dashboard. Although not illustrated in FIG. 3, the third cable 54 connects the processor 46 to the fluids chamber 36 which communicates fluid through the tube 34 to the housing 12.

As the tire 18 generates heat, the resultant thermal field 58 is sensed by the receiver 42 mounted to the shroud 62. The thermal characteristics of the thermal field 58 are then processed by the device 10 in like manner as that fully described in relation to the first embodiment. The supporting arms 86 maintain the shroud 62 at a substantially fixed distance relative to the tires so that the detected thermal fields of each signal is substantially uniform. It is to be appreciated that the embodiment illustrated in FIG. 3 is particularly suited for application to motorcycles; however, FIG. 5 illustrates a cantilever embodiment in accordance with this disclosure that is gainfully employed in other motor vehicles, such as trucks or cars with relatively large gaps between the fender defining the wheel well 16 and the tire 18. In FIG. 5, the display 50 is illustrated with a running series of signals 87, with a warning signal 89 displayed in response to increased temperature caused by a nail 91 in the tire 18. Further, the display 50 illuminates a lamp 93 in response to receiving the abnormal display signal. An enunciator 95 communicates an alert tone or sound to the observer, so that the abnormal signal is not overlooked inadvertently or by some other distraction.

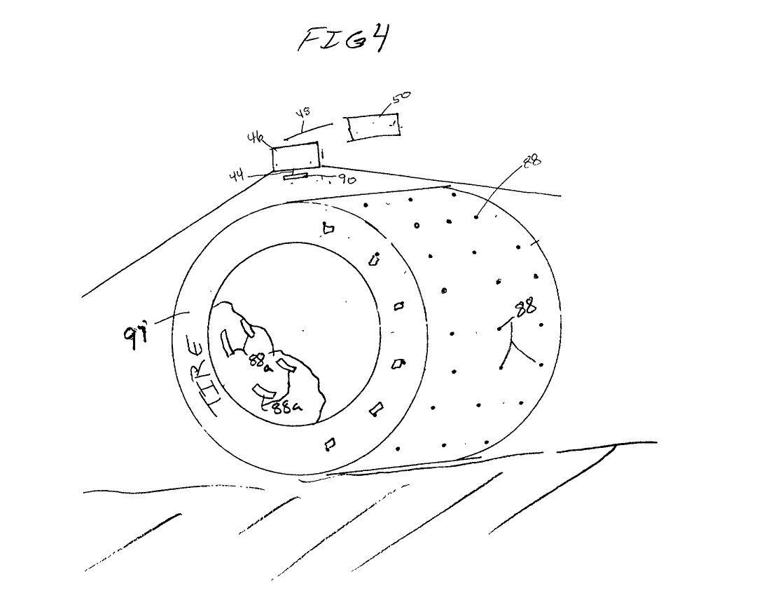

Referring now to FIG. 4, there is shown a third embodiment of the present invention which utilizes at least one thermal sensor 88, but preferably a spaced apart plurality of thermal sensors 88, embedded in a tire 97. The embedded sensor 88 is adapted to sense thermal characteristics of the tire 97 and convert the characteristics into a remotely sensed signal. A signal receiver 90 remotely housed in the body of the vehicle 11 is adapted to receive the signal emitted by the sensor 88 and, at a pre-set time interval, convert the signal into an electrical signal or impulse representative of the thermal characteristic of the tire sensed by the thermal sensor 88 embedded in the tire 97.

The receiver 90 also generates a second signal representative of the signal received from the sensor 88. The receiver 90 communicates the second signal through the first cable 44 to the processor 46 mounted in a remote portion of the vehicle 11. The processor 46 receives the signals generated by the receiver 90. The processor 46 compares the signal representative of the detected thermal characteristic with the characteristic of historically received signals stored in the memory of the processor 46. The processor 46 takes a specified course of action depending upon the relative similarity or difference between the characteristic of the most recently received signal and the historical data stored by the processor 46. Similar to the construction and function of the first embodiment, the first cable 44 connects the remote receiver 90 to the processor 46 and the second cable 48 connects the processor 46 to the display 50 installed in the dashboard 52.

FIG. 4 illustrates the sensors 88 disposed in an array between adjacent plies of the belts that make up the perimeter portions of the tire 97. Also illustrated are sensors 88a embodied in patches having an adhesive surface that bonds the sensor to an interior surface of the tire, as an alternate embodiment.

In use, the receiver 90 shown in FIG. 4 communicates the second signal through the first cable 44 to the processor 46. The processor 46 compares the thermal characteristic with the value of the historic thermal characteristic maintained by the processor 46. If the most recent thermal characteristic is within a predetermined allowable variance from the historical thermal data stored in the processor 46, then the processor 46 includes the most recent thermal characteristic with the historical thermal characteristic stored in the processor 46. The receiver 42 continues to receive signals representative of the thermal field 58 generated by the tire 97 and transmitted by the embedded sensors 88, and continues to communicate the signals to the processor 46.

However, if the most recent signal communicated by the receiver 90 is outside the pre-determined allowable variance in the historical thermal characteristic stored by the processor 46, an alert is communicated to the display 50 because tire failure may be possible. Where the thermal characteristic exceeds the thermal characteristic threshold for the tire 97, the processor 46 generates an abnormal signal representative of the abnormal thermal characteristic. The abnormal signal is communicated by the second cable 48 to the display monitor 50. The display monitor 50 presents an image representative of the abnormal signal, as discussed above. An observer of that image is thereby alerted to abnormal thermal characteristics generated by the tire 18 and can attend to the condition causing the abnormal signal before the tire 97 fails.

In the practice of the present invention, the receiver 42 is preferably a thermal sensor, but other temperature monitoring devices, such as an optical imaging device, a CCD device, or an infrared imaging device could be used without deviating from the invention. Further, although the first and second preferred embodiments are illustrated with apparatus that utilizes pressurized fluid 38 to remove debris from the cover 22, other cleaning means are gainfully used in the present invention, for example and not limited to, pressurized air which may be pumped from the chamber 36 through the tube 34 and onto the cover 22 in the housing 12, wipers, and the like. Also, it should be understood that although the embodiments depicted in the FIGS. 1 and 3 show a single receiver mounted to the vehicle 11, multiple receivers 42 could be mounted to the vehicle 11 in locations including, but not limited to, the wheel well 16 or shroud 62 so as to permit simultaneous monitoring of the thermal characteristics of multiple areas of the tire 18, including the tread 56 and side wall portions of the tire 18. Although FIG. 3 displays a shroud 62 mounted to a U-shaped biasing device 72 at joinder points 84 on either side of the wheel 82, the shroud 62 may be mounted to other biasing devices 71, including a flying arm, and joined to the vehicle in other joinder point 84 locations, such as to the undercarriage of the vehicle 11.

The present invention accordingly provides an apparatus for detecting tire failure. The principles, preferred embodiments, and modes of operation of the present invention have been described in the foregoing specification. The invention is not to be construed as limited to the particular forms disclosed because these are regarded as illustrative rather than restrictive. Moreover, variations and changes may be made by those skilled in the art without departure from the spirit of the invention as described by the following claims.

What is claimed is:

1. A tire failure detector, comprising:
a receiver mounted in a housing adapted for being attached to a portion of a motor vehicle for generating a signal representative of a thermal characteristic of a portion of a tire sensed by the receiver;
a cover disposed at a first end of the housing protecting the receiver from debris;
a processor for detecting an abnormal signal connected by a carrier to the receiver for communicating the signal therefrom; and
a display operated by the processor for presenting at least an image representative of the detected abnormal signal;
whereby an observer, detecting the display of an abnormal signal, attends to the condition causing the abnormal signal.

2. The tire failure detector as recited in claim wherein the housing defines an elongate barrel open at a distal end thereof, the cover disposed remote therefrom for imaging through the barrel.

3. The tire failure detector as recited in claim 2, wherein the housing mounts to a portion of a wheel well of the motor vehicle.

4. The tire failure detector as recited in claim 1, further comprising:
a supply of a pressurized fluid;
a nozzle mounted relative to the housing for spraying a stream of the pressurized fluid therein;
a tube connecting the supply of the pressurized fluid to the nozzle;
whereby the nozzle communicates the pressurized fluid for cleaning debris from the housing.

5. The tire failure detector as recited in claim 3, wherein the housing defines an outlet closed by a one-way valve for discharging debris and sprayed fluid from the housing.

6. The tire failure detector as recited in claim 1, wherein the receiver comprises an optical imaging device.

7. The tire failure detector as recited in claim 1, wherein the receiver comprises an infrared imaging device.

8. The tire failure detector as recited in claim 1, wherein the receiver comprises a thermal sensing device.

9. The tire failure detector as recited in claim 1, further comprising a second receiver and a third receiver mounted to the motor vehicle on facing opposing sides for generating signals representative of a thermal characteristic of a respective side wall portion of the tire.

10. The tire failure detector as recited in claim 1, wherein the portion of the motor vehicle comprises a shroud for being spaced-apart from the tire.

11. The tire failure detector as recited in claim 10, wherein the shroud is mounted to a biasing device for maintaining a predetermined gap between the housing and the tire subject of observation by the receiver.

12. The tire failure detector as recited in claim 1, further comprising:
a tire mounted to a wheel of the motor vehicle for being observed by the receiver;
a plurality of thermal sensors distributed in spaced-apart relation in the tire for changing in response to temperature changes in the tire;
whereby the receiver detects the changing thermal sensors for communicating a signal representative thereof to the processor.

13. The tire failure detector as recited in claim 12, wherein the thermal sensors include an adhesive surface for attaching the thermal sensors to an interior surface of the tire.

14. The tire failure detector as recited in claim 12, wherein the thermal sensors are embedded between adjacent plies of the tire.

15. A tire failure detector, comprising:
at least one thermal receiver mounted in a housing having an elongate barrel defining a thermal communicating field for the thermal receiver which generates a signal representative of a thermal characteristic of a portion of a tire sensed by the receiver, the housing adapted for being attached to a portion of a motor vehicle;
a transparent cover disposed at a first end of the housing protecting the receiver from debris;
a supply of a pressurized fluid;
a nozzle mounted relative to the housing for spraying a stream of the pressurized fluid therein;
a tube connecting the supply of the pressurized fluid to the nozzle;
whereby the nozzle communicates the pressurized fluid for cleaning debris from the cover.
a processor for detecting an abnormal signal connected by a carrier to the receiver for communicating the signal therefrom; and
a display operated by the processor for presenting at least an image representative of the detected abnormal signal;
whereby an observer, detecting the display of an abnormal signal, attends to the condition causing the abnormal signal.

16. The tire failure detector as recited in claim 15, wherein the housing defines an outlet closed by a one-way valve for discharging debris and sprayed fluid from the housing.

17. The tire failure detector as recited in claim 15, wherein the receiver comprises an optical imaging device.

18. The tire failure detector as recited in claim 15, wherein the receiver comprises an infrared imaging device.

19. The tire failure detector as recited in claim 15, wherein the receiver comprises a thermal sensing device.

20. The tire failure detector as recited in claim 15, further comprising a second receiver and a third receiver mounted to the motor vehicle on facing opposing sides for generating signals representative of a thermal characteristic of a respective side wall portion of the tire.

21. The tire failure detector as recited in claim 15, wherein the portion of the motor vehicle comprises a shroud for being spaced-apart from the tire.

22. The tire failure detector as recited in claim 21, wherein the shroud is mounted to a biasing device for maintaining a predetermined gap between the housing and the tire subject of observation by the receiver.

23. The tire failure detector as recited in claim 15, further comprising:
a tire mounted to a wheel of the motor vehicle for being observed by the receiver;
a plurality of thermal sensors distributed in spaced-apart relation in the tire for changing in response to temperature changes in the tire;
whereby the receiver detects the changing thermal sensors for communicating a signal representative thereof to the processor.

24. The tire failure detector as recited in claim 23, wherein the thermal sensors include an adhesive surface for attaching the thermal sensors to an interior surface of the tire.

25. The tire failure detector as recited in claim 23, wherein the thermal sensors are embedded between adjacent plies of the tire.
